(19) United States
(12) Patent Application Publication
(10) Pub. No.: US 2006/0092319 A1
(43) Pub. Date: May 4, 2006

(54) Image pickup apparatus

(75) Inventor: Masanori Ohnishi, Hirakata-shi (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi (JP)

(21) Appl. No.: 11/250,147

(22) Filed: Oct. 13, 2005

(30) Foreign Application Priority Data
Oct. 18, 2004 (JP) 2004-302611

(51) Int. Cl. H04N 5/225

(52) U.S. Cl. 348/375

(57) ABSTRACT

An image pickup apparatus includes a recording/reproducing part having a turntable for rotating a disk-shaped medium, an optical pickup, and a disk open/close cover for covering the disk-shaped medium under the condition that the disk-shaped medium is fitted to the turntable part, a monitor part for allowing a video signal output from an image pickup part to be recognized visually, and a body part in which the recording/reproducing part and the monitor part are placed. The recording/reproducing part is placed along one outer wall among outer walls constituting the body part, and the monitor part is placed so as to be overlapped with a projection plane of the disk open/close cover on an outer surface of the disk open/close cover opposed to the turntable. Thus, the operability and the holding property of the image pickup apparatus can be enhanced.

### BACKGROUND OF THE INVENTION

1. Field of the Invention

The present invention relates to an image pickup apparatus capable of recording a video signal on a disk-shaped medium having an information layer and reproducing a video signal recorded on the disk-shaped medium.

2. Description of Related Art

Conventionally, as an image pickup apparatus, a camcorder that records a moving image video signal and an audio signal on tapes accommodated in various kinds of cassettes, and an electronic still camera that records a captured still image on a semiconductor memory have been the mainstream.

In the meantime, owing to the advancement of video compression technology, a moving image has come to be able to be recorded on an information medium with a small recording capacity. Furthermore, due to the enhancement of the recording density of a disk-shaped medium, the decrease in a laser wavelength for recording/reproducing information with respect to the disk-shaped medium, and the enhancement of performance of optical components such as a lens, an optical pickup, and a traverse, it becomes possible to perform miniaturization and reduction in thickness of constituent devices. This enables a disk recording/reproducing part to be of a “palm-size”, and a camcorder with the disk recording/reproducing part mounted thereon has started to spread. The configuration in which the disk recording/reproducing part is mounted on the electronic still camera is also being considered.

On the other hand, the electronic still camera generally is provided with a monitor composed of a liquid crystal display of about 2 to 4 inches on the surface of an electronic still camera and a camcorder (hereinafter, referred to as a “body”), as well as a viewfinder through which a user can visually recognize an image. The monitor is designed in such a manner that a display surface thereof is placed so as to be orthogonal to an optical axis of a lens.

Furthermore, recently, a camcorder having a monitor that can be accommodated in a body as well as a viewfinder is spreading, in response to the demands such as the variety of a photographing style and the immediacy of reproducing a captured video signal on the spot. Patent Document 1 (JP 10(1998)-65946 A) describes a configuration in which a monitor can be accommodated in a camcorder.

As shown in FIGS. 7 and 8, the configuration described in Patent Document 1 includes a cassette inserting part 104 capable of inserting a tape cassette 105 in a camcorder 103, and a monitor 101 is provided rotatably on the cassette inserting part 104.

In a disk-shaped medium, under the condition of the same recording density of an information layer, the recording capacity of a disk is proportional to the area (i.e., a disk diameter) of the information layer, so that a larger disk diameter is advantageous in terms of a recording capacity. However, an electronic still camera and a camcorder usually are used outdoors; therefore, if the electronic still camera and the camcorder are configured so that a general widespread disk with a diameter of 12 cm can be attached/detached, the body is enlarged, which degrades the portability. Thus, the body can be miniaturized if the electronic still camera and the camcorder are configured so that a disk with a diameter of 8 cm can be attached/detached.

However, the area of a recording surface of the disk with a diameter of 8 cm is larger than that of a main surface of a tape cassette (a DV mini-cassette containing a magnetic tape with a width of ¼ inches) applied to a camcorder, so that the space for accommodating a disk in the camcorder becomes larger by about 1.6 times or more, compared with the space in which a video tape cassette can be inserted. Furthermore, the area of the main surface of the disk with a diameter of 8 cm is much larger than that of a semiconductor memory such as a memory card, which makes it impossible to miniaturize a body.

In view of the above, regarding a camcorder in which a disk apparatus is mounted, for example, a configuration as shown in FIGS. 9A to 11C has been proposed.

As shown in FIGS. 9A to 9C, the camcorder includes an image pickup lens 201, a camera body 202, a monitor 203 provided with a display part 203a, a disk apparatus part 204, a monitor rotation shaft 205, a monitor bearing 206, a finder 207, a release button 208, a band 209, a disk open/close cover rotation shaft 210, a disk open/close cover 211, and a turntable 212.

As shown in FIGS. 9A to 9C, the disk apparatus part 204 and the monitor 203 are placed on side surfaces of the camera body 202 opposed to each other. The band 209 is placed on the disk open/close cover 211 of the disk apparatus part 204. There is a gap in which the hand of a user can be inserted, between the band 209 and the disk open/close cover 211.

When photographing is performed with the camcorder in a state shown in FIGS. 9A, 9B, and 9C, the monitor 203 is rotated in a direction represented by an arrow Z around the monitor rotation shaft 205, and is shifted to a state shown in FIGS. 10A and 10B.

Next, in FIGS. 10A and 10B, the user inserts the hand between the band 209 and the disk open/close cover 211, and holds the camcorder with the hand. Next, the user turns on a power supply of the camcorder by operating a power supply button (not shown), whereby signal processing is performed in an image pickup element and an electric circuit contained in the camcorder, and a video signal is generated based on optical information captured by the image pickup element. The generated video signal is displayed on the finder 207 or the monitor 203. The user presses down the release button 208 while watching a video that is being captured, displayed on the finder 207 or the monitor 203, and thus, can record a video signal (a still image or a moving image) that is being captured on a disk.

Furthermore, when a moving image or a still image recorded on a disk is reproduced, a reproduced video signal is displayed on the finder 207 or the monitor 203. It is preferable that the reproduced video signal is visually recognized through the display part 203a of the monitor 203. The reason for this is that the size of the display part 203a of the monitor 203 is larger than that of the display part of the finder 207, and it is easier to recognize the video signal visually through the display part 203a.

When a disk is attached/detached with respect to the disk apparatus part 204, the disk open/close cover 211 is rotated around the disk open/close cover rotation shaft 210 in FIG. 10A so as to obtain an open cover state as shown in FIGS. 11A and 11B. In this state, the disk 212 can be attached/detached with respect to the turntable.

Herein, regarding the configuration disclosed in Patent Document 1, the external dimension of a DV mini-cassette is smaller than that of a tape cassette of a VHS-C system, and the mechanism corresponding to the DV mini-cassette can be smaller than that corresponding to a VHS-C system. Therefore, a space capable of accommodating the monitor 101 can be provided on an outer side of the cassette inserting part 104.

However, as shown FIGS. 9A to 11C, the camcorder with the disk apparatus mounted thereon needs a space for accommodating a disk with a diameter of 8 cm, which increases the bulk of the disk apparatus part 204. Thus, the disk apparatus part 204 cannot help being placed on a side surface of the camera body 202.

Furthermore, for example, in a camcorder with only the finder 207 mounted thereon without the monitor 203, the disk apparatus part 204 can be placed on one side surface of the camera body 202, the band 209 can be placed on the other side surface of the camera body 202, the release button 208 can be placed at a position where the thumb can reach, and a zoom button altering the focal length of the image pickup lens 201 can be placed at a position (for example, an upper surface of the camera body 202 as in zoom switches 107 in FIG. 8) where the forefinger and the middle finger can reach.

However, as shown in FIGS. 9A to 11C, in the case of the camcorder provided with both the finder 207 and the monitor 203, it is necessary to place the disk apparatus part 204 on one side surface of the camera body 202, and place the monitor 203 on the other side surface of the camera body 202. Furthermore, as shown in FIG. 10A, the band 209 cannot be attached to the monitor 203 side, and needs to be attached to an outer side of the disk open/close cover 211. In such a configuration, assuming that the user holds the camcorder with one hand (usually, the right hand), the release button 208 can be placed at a position where the thumb can reach. However, as shown in FIG. 8, when an attempt is made so as to place the zoom buttons 107 on an upper surface of the camera body 202, the forefinger and the middle finger may be unlikely to reach the zoom buttons 107 due to the large bulk of the disk apparatus 204. Thus, there is a problem that a zoom operation becomes difficult.

Furthermore, when the camcorder is held with the hand using the band 209, since the disk apparatus part 211 has a large bulk, and the surface thereof is substantially flat as shown in FIG. 9B, there is a problem that a grip property is low. More specifically, when the camcorder is held with the hand, the palm needs to remain substantially opened, so that it is difficult to shut the palm, which degrades the grip property of holding the camera body 202, and makes it easy for the camera body 202 to be slippery during photographing due to the weight thereof

### SUMMARY OF THE INVENTION

The present invention has been achieved in view of the above-mentioned problems, and its object is to provide an image pickup apparatus with operability and holding property enhanced.

In order to solve the above-mentioned problem, an image pickup apparatus of the present invention allows a disk-shaped medium having an information layer to be attached/detached and is capable of recording/reproducing at least a video signal on an information layer of the disk-shaped medium. The apparatus includes: a lens part for allowing optical information to form an image on an image pickup element that converts the optical information into a video signal; a recording/reproducing part including a rotation part provided with a turntable fitted in a center hole of the disk-shaped medium, an optical pickup for transmitting/receiving the video signal with respect to the information layer, and a disk open/close cover covering the disk-shaped medium when the disk-shaped medium is fitted to the turntable part; a monitor part enabling a video signal output from the image pickup part to be recognized visually; and a body part in which the lens part, the recording/reproducing part, and the monitor part are placed, wherein the recording/reproducing part is placed along one outer wall among outer walls constituting the body part, and the monitor part is placed so as to be overlapped with a projection plane of the disk open/close cover, on an outer surface of the disk open/close cover opposed to the turntable.

According to the above configuration, the monitor is placed on the disk open/close cover, so that the operability and the holding property of the image pickup apparatus can be enhanced.

### BRIEF DESCRIPTION OF THE DRAWINGS

FIG. 1A is a front view showing a configuration of an image pickup apparatus according to Embodiment 1 of the present invention.

FIG. 1B is a plan view showing the configuration of the image pickup apparatus according to Embodiment 1.

FIG. 1C is a side view showing the configuration of the image pickup apparatus according to Embodiment 1.

FIG. 2A is a plan view showing a photographing state of the image pickup apparatus according to Embodiment 1.

FIG. 2B is a front view showing the configuration of the image pickup apparatus according to Embodiment 1.

FIG. 3A is a plan view showing a state during disk exchange of the image pickup apparatus according to Embodiment 1.

FIG. 3B is a front view showing a state during disk exchange of the image pickup apparatus according to Embodiment 1.

FIG. 4A is a front view showing a configuration of a monitor in Embodiment 1.

FIG. 4B is an exploded side view showing the configuration of the monitor in Embodiment 1.

FIG. 5A is a left side view showing a configuration of a disk cover in another embodiment of the image pickup apparatus.

FIG. 5B is a plan view showing the configuration of the disk cover in another embodiment of the image pickup apparatus.

FIG. 5C is a bottom view showing the configuration of the disk cover in another embodiment of the image pickup apparatus.

FIG. 5D is a cross-sectional view taken along a line Y-Y in FIG. 5B.

FIG. 6A is a front view showing a configuration of still another embodiment of the image pickup apparatus.

FIG. 6B is a plan view showing the configuration of still another embodiment of the image pickup apparatus.

FIG. 6C is a side view showing the configuration of still another embodiment of the image pickup apparatus.

FIG. 7 is a perspective view showing a conventional image pickup apparatus.

FIG. 8 is a plan view showing the conventional image pickup apparatus.

FIG. 9A is a front view showing another example of the conventional image pickup apparatus.

FIG. 9B is a plan view showing another example of the conventional image pickup apparatus.

FIG. 9C is a side view showing another example of the conventional image pickup apparatus.

FIG. 10A is a plan view showing a photographing state of the conventional image pickup apparatus.

FIG. 10B is a front view showing a photographing state of the conventional image pickup apparatus.

FIG. 11A is a plan view showing a state during disk exchange of the conventional image pickup apparatus.

FIG. 11B is a front view showing a state during disk exchange of the conventional image pickup apparatus.

### DETAILED DESCRIPTION OF THE INVENTION

The image pickup apparatus of the present invention can be configured in such a manner that the one outer wall having the recording/reproducing part is placed in parallel with an optical axis center of the lens part. According to this configuration, an image pickup apparatus having a recording/reproducing part and a monitor part can be miniaturized.

Furthermore, the image pickup apparatus of the present invention can be configured so as to further include: an operation part having a photographing operation part for starting recording of a video signal and stopping recording of the video signal with respect to the information layer, and a zoom operation part capable of performing a zooming operation of a video signal output from the image pickup part; and a holding assist part for assisting in holding of the body part, wherein the operation part is placed in a vicinity of the holding assist part. According to this configuration, various operations regarding photographing can be concentrated in one hand, and the operability of photographing can be enhanced.

Furthermore, the image pickup apparatus of the present invention can be configured so as to include a concave part that is buried in an outer wall of the open/dose cover in a direction toward the rotation part, wherein the concave part accommodates the monitor part. According to this configuration, the accommodation state of an image pickup apparatus having a recording/reproducing part and a monitor part can be rendered compact.

Furthermore, the image pickup apparatus of the present invention can be configured in such a manner that a rotation shaft of the monitor part is formed coaxially with a rotation shaft of the disk open/close cover. According to this configuration, only one bearing suffices, so that a material cost can be reduced, and the image pickup apparatus can be miniaturized, compared with the configuration including independent bearings.

Furthermore, the image pickup apparatus of the present invention can be configured so as to include an opening in a vicinity of a position where the disk open/close cover is opposed to the turntable. According to this configuration, the protrusion of the turntable of the recording/reproducing part can be absorbed by the opening, and the recording/reproducing part can be rendered thin. Thus, the miniaturization and reduction in thickness of an image pickup apparatus can be realized.

### Embodiment 1

Next, a preferable embodiment of the image pickup apparatus of the present invention will be described with reference to the drawings. In the following description, regarding a disk-shaped medium that can be attached to the image pickup apparatus, a disk (which also may be called a bare disk) that is not accommodated in a cartridge will be described; however, a disk accommodated in a cartridge also may be used. An image pickup apparatus capable of using a disk-shaped medium accommodated in a cartridge may be obtained merely by adding a cartridge inserting member, and the main configuration thereof is the same as that of an image pickup apparatus capable of using a bare disk.

Furthermore, as the image pickup apparatus of the present embodiment, although a camcorder will be exemplified, which includes a disk recording/reproducing device capable of recording/reproducing an information signal with respect to a DVD (Digital Versatile Disk) and a monitor capable of displaying a video that is being captured, a video reproduced from a DVD, or the like, any image pickup apparatus may be used as long as it includes both a disk recording/reproducing device and a monitor. Furthermore, an information medium that can be attached/detached with respect to the image pickup apparatus may be a disk-shaped medium with a density higher than that of the DVD. Furthermore, the disk diameter of the disk-shaped medium is not limited to 12 cm or 8 cm, and other disk diameters may be used. Furthermore, an electronic still camera may be used in place of the camcorder. In any variation, the functional effects to be obtained are the same.

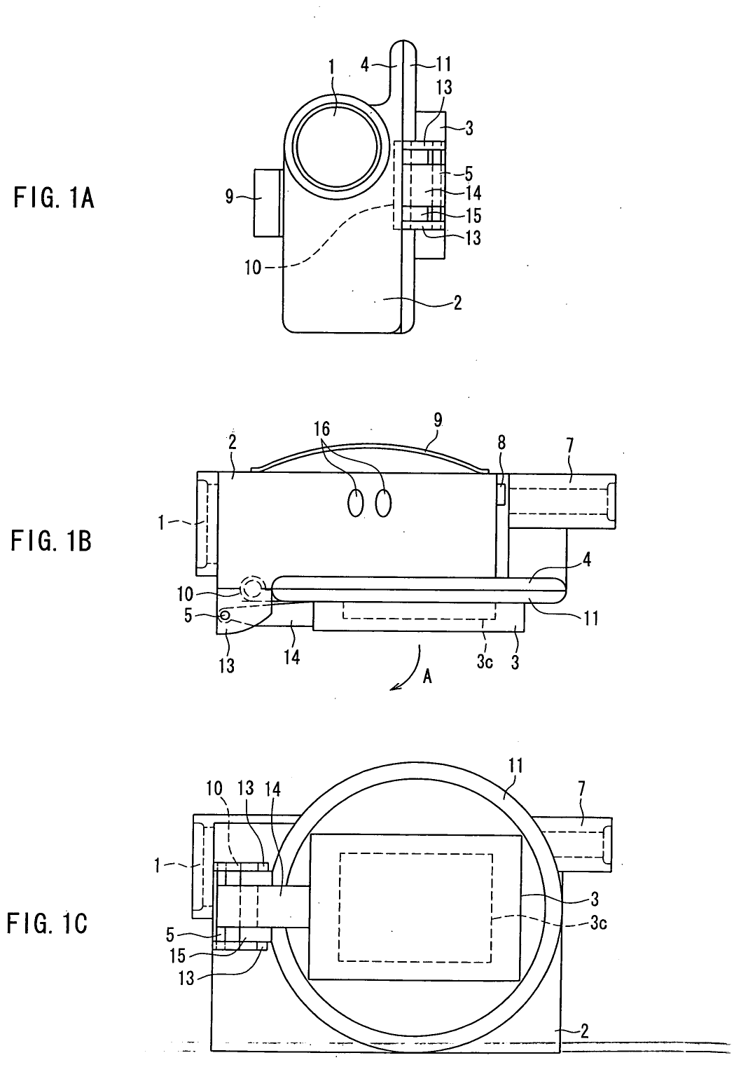

FIG. 1A is a front view showing a state in which a monitor is accommodated in the camcorder in Embodiment 1. FIG. 1B is a plan view, and FIG. 1C is a side view seen from the monitor side.

In FIGS. 1A to 1C, a camera body 2 contains an image pickup element that converts an optical signal incident through an image pickup lens 1 into an electric signal, a circuit board on which a signal processing circuit and the like are mounted, a mechanism that drives a disk-shaped medium, and the like. A monitor 3 is placed rotatably on a side surface of the camera body 2, and includes a display element 3c capable of displaying a video that is being captured, a video reproduced from a disk-shaped medium, or the like. Although the display element 3c is composed of, for example, a liquid crystal display, the display element 3c is not limited thereto and may be an organic EL element or the like. A disk apparatus part 4 allows a disk-shaped medium to be attached/detached with respect to the inside thereof, and can record or reproduce information with respect to the attached disk-shaped medium. A monitor rotation shaft 5 allows the monitor 3 to be axially supported rotatably. A finder 7 is capable of displaying a video that is being captured, a video reproduced from the disk-shaped medium, or the like, and is configured in such a manner that a user can recognize the video visually by looking through the finder 7. A release button 8 is placed at a position of the camera body 2 where the user can operate the release button 8 so as to capture a moving image or a still image, and can operate the release button 8 with the thumb of the user. A band 9 allows the user to insert the hand therein and holds the camcorder stably. Furthermore, in the camera body 2, the band 9 is placed on a side surface opposed to the side surface on which the monitor 3 and the disk apparatus part 4 are placed. A disk open/close cover 11 is placed so as to be opened/closed with respect to the disk apparatus part 4 and rotated around a disk open/close cover rotation shaft 10. A bearing 13 is provided on a side surface of the camera body 2, and supports the monitor rotation shaft 5 and the disk open/close cover rotation shaft 10. A monitor rib 14 connects the monitor rotation shaft 5 to the monitor 3, and may be configured integrally with or separately from the monitor 3. In the case where the monitor rib 14 is configured as a separate member, it is preferable that a shaft orthogonal to the monitor rotation shaft 5 is placed in the monitor rib 14, and the monitor 3 is configured so as to be rotated around the shaft with respect to the monitor rib 14. A disk open/close cover rib 15 connects the disk open/close cover 11 to the disk open/close cover rotation shaft 10. Zoom operation buttons 16 can be operated so as to alter the focal position of a lens, and are placed on an upper surface of the camera body 2.

As shown in FIGS. 1A, 1B, and 1C, in the image pickup apparatus of the present embodiment, the disk apparatus part 4 and the monitor 3 are placed on one side surface of the camera body 2, and only the band 9 that is a holding assist allowing the user to hold the camera body 2 is placed on the other side surface of the camera body 2. Because of this, the height of the side surface on which the belt 9 is placed in the camera body 2 does not depend upon the height of the disk apparatus part 4, and can be decreased. Thus, when the user inserts the hand in a gap between the side surface of the camera body 2 and the band 9 from a lower direction, and holds the camera body 2 with the hand, the user can hold the camera body 2 with the fingers bent along the upper surface of the camera body 2 from the side surface thereof. Thus, the same satisfactory holding property as that of a digital camcorder to which a tape cassette is applicable can be realized while both the disk apparatus part 4 and the monitor 3 are provided.

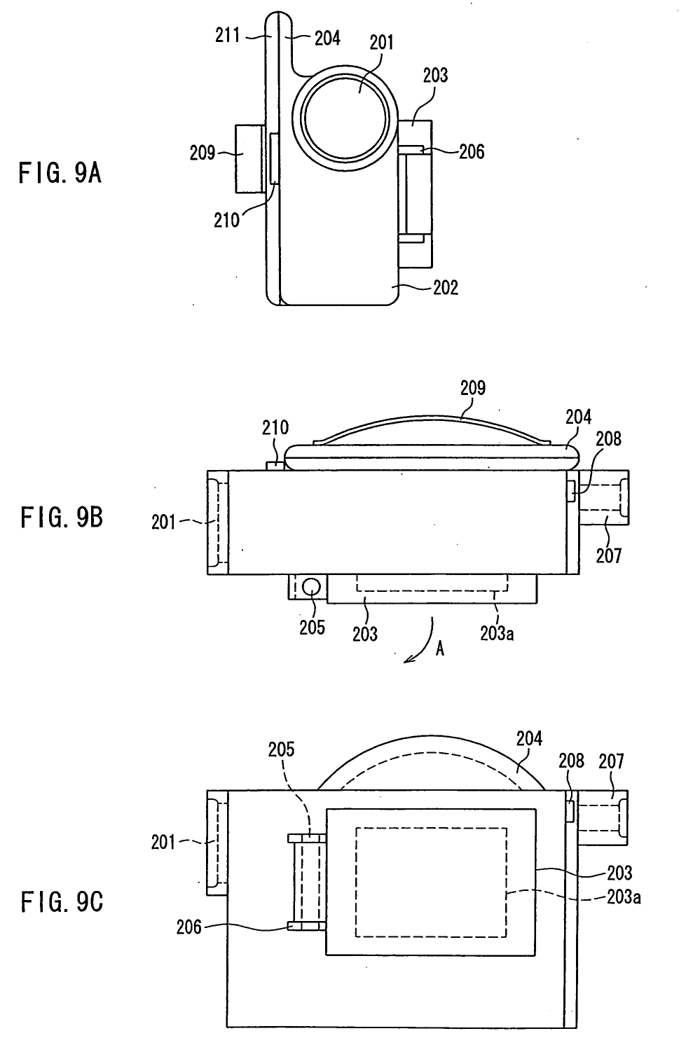

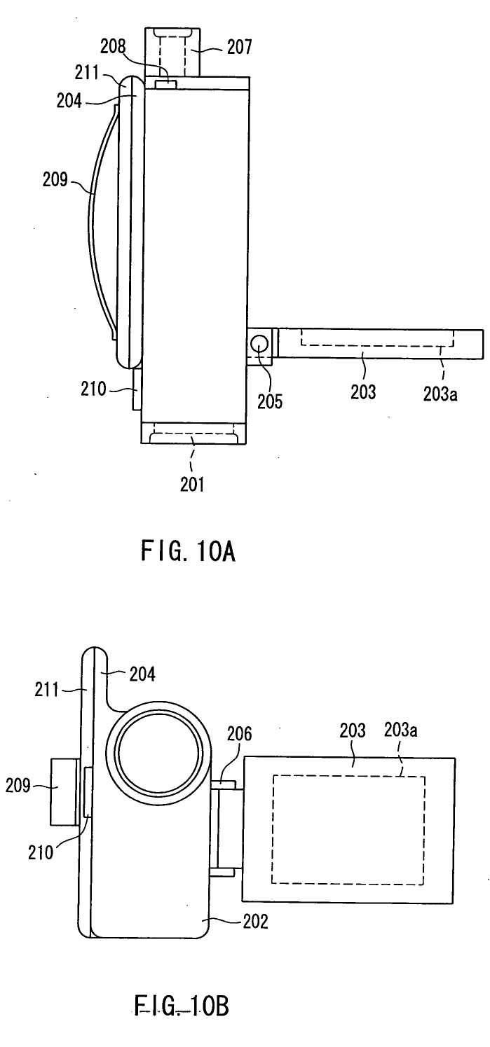

Furthermore, as shown in FIG. 1B, the release button 8 and the zoom buttons 16 can be placed at the same positions as those of the digital camcorder. Consequently, all the button operations required for photographing can be performed with one hand, so that the effect of enhancing the operability is remarkable, compared with the operability of, for example, the conventional camcorder shown in FIG. 9B.

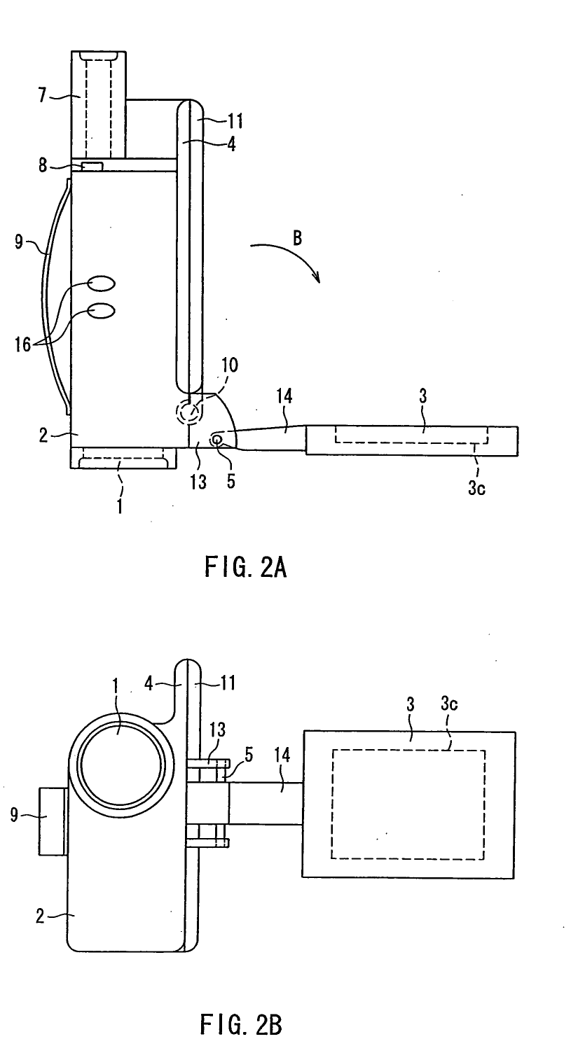

Next, FIG. 2A is a plan view showing a state during photographing by the camcorder of the present embodiment. FIG. 2B is a front view of the camcorder. As shown, although a photographer can select an object to be captured through the finder 7, only a very narrow range can be recognized visually merely with the finder 7, so that it is convenient to select an object to be captured through the monitor 3. The photographer can hold the camcorder with the posture of inserting the right hand on an inner side of the band 9, placing the thumb on the release button 8, and bending the remaining fingers along an arc-shaped curved surface. Therefore, the button operations during photographing can be completed with one hand while the holding property is satisfactory as described above.

The monitor 3 contains a display for displaying a video or the like that is being captured so that the video or the like can be checked visually, and the monitor rib 14 is placed integrally with the monitor 3. The monitor rotation shaft 5 is inserted in a tip end of the monitor rib 14, and axially supports the monitor 3 to the bearing 13 of the camera body 2 so that the monitor 3 can be rotated. The monitor 3 is rotated around the monitor rotation shaft 5 by a predetermined angle from the disk open/dose cover 11 with the lengths of the monitor rib 14 and the monitor 3 being a radius. The photographer can adjust the focal length of the lens 1 by zooming up or zooming down the object to be captured with the zoom operation buttons 16 while watching a video appearing on the rotated monitor 3. Furthermore, the photographer can start or stop photographing by pressing down the release button.

In the present embodiment, a shaft hole of the bearing 13 supporting the monitor rotation shaft 5 is placed at a position slightly away from the surface of the camera body 2. Therefore, when the monitor 3 is rotated from the position in FIG. 1 to the position in FIG. 2, the interference between the monitor 3 and the camera body 2 can be prevented. This can enlarge the rotation angle of the monitor 3, and enhance the visibility of the monitor 3 during photographing or reproduction.

Next, an operation of attaching/detaching a disk-shaped medium with respect to the camcorder will be described.

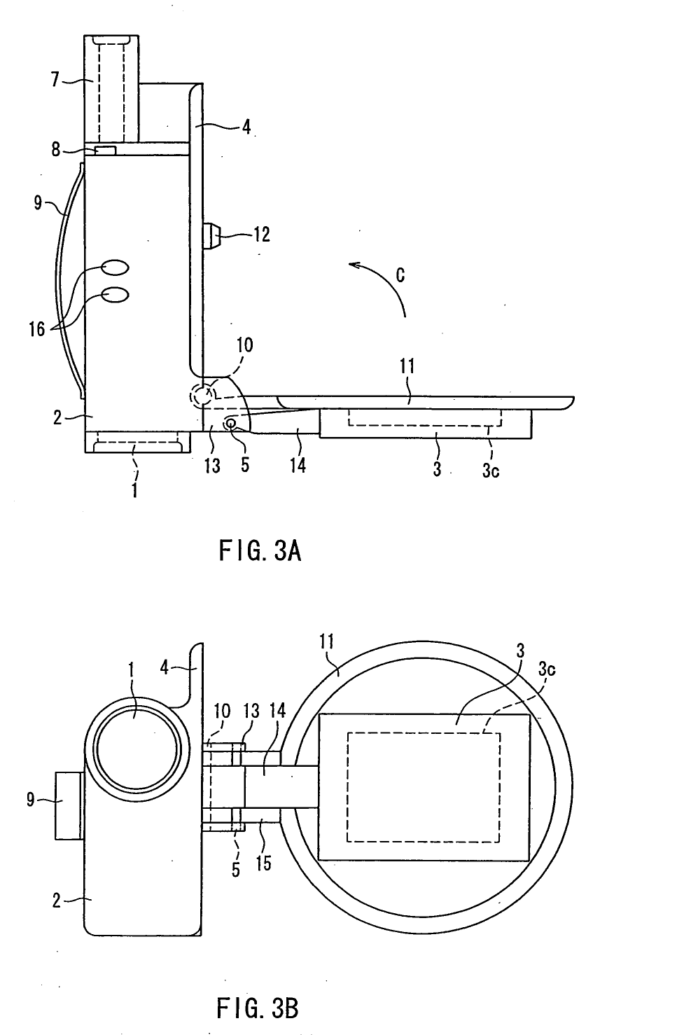

FIG. 3A is a plan view of a state in which the disk-shaped medium can be attached/detached with respect to the camcorder, and FIG. 3B is a front view thereof. When the disk-shaped medium is exchanged in the camcorder, the disk open/dose cover 11 is rotated from the state in which the open/close cover 11 is closed (see FIGS. 2A and 2B) in a direction represented by an arrow B around the disk open/close cover rotation shaft 10 to obtain the state shown in FIGS. 3A and 3B. When the disk open/dose cover 11 is opened as shown in FIGS. 3A and 3B, a turntable 12 is exposed. Next, a disk-shaped medium (not shown) is attached to the turntable 12, and thereafter, the disk open/dose cover 11 is rotated in a direction represented by an arrow C to bring the disk apparatus part 4 into a closed state, whereby the attachment of the disk-shaped medium is completed.

In the above description, the case of newly attaching a disk-shaped medium to the camcorder to which a disk-shaped medium has not been attached is described. However, the attachment operation can be performed in the same way even in the case of exchanging a disk-shaped medium attached to the disk apparatus part 4 and storing video and audio signals and the like with another disk-shaped medium. More specifically, a recorded disk-shaped medium attached to the camcorder merely is removed from the turntable 12 and another disk-shaped medium is attached. Thus, the attachment operation is the same as that described above. Furthermore, the turntable 12 in the present embodiment also has a clamper function in which the turntable 12 is fitted in a center hole of a disk-shaped medium and is capable of holding the disk-shaped medium.

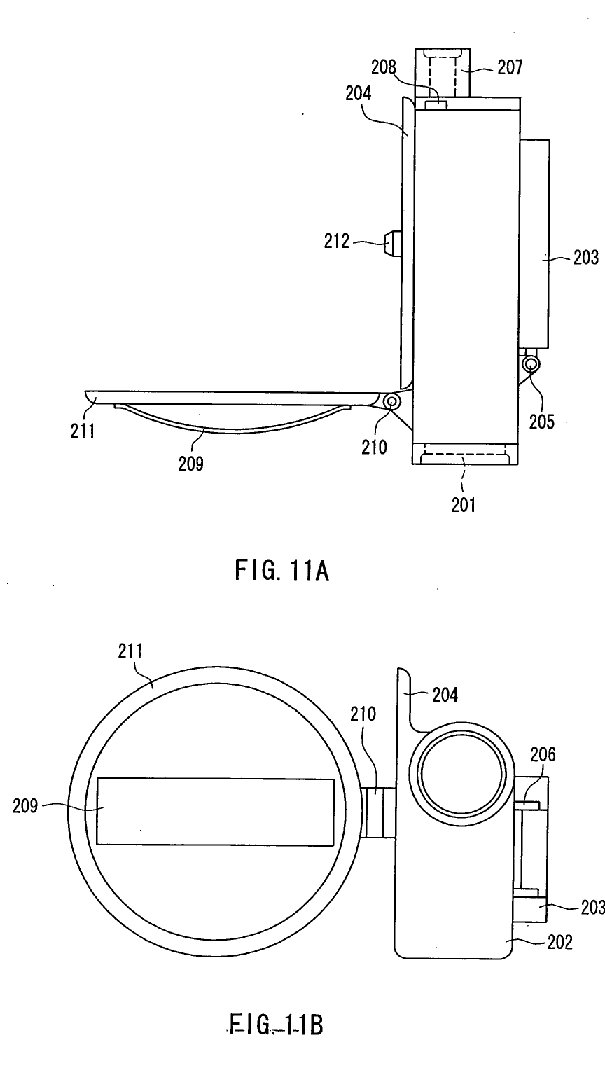

In the configuration of the conventional DVC shown in FIG. 11, one hand (the right hand in the figure) inserted in the band 209 is first removed from the band 209, and thereafter, the disk open/close cover 211 is opened, whereby a disk-shaped medium is attached or exchanged. In contrast, in the camcorder according to the present embodiment, as shown in FIGS. 3A and 3B, the belt 9 and the disk apparatus part 4 are placed on the side surfaces different from each other in the camera body 2. Therefore, while the camera body 2 is held in one hand (the right hand in the shown configuration), a disk-shaped medium can be attached or exchanged with the other hand (the left hand in the shown configuration). Thus, the time required for attaching or exchanging a disk-shaped medium can be shortened to enhance the operability.

Furthermore, the operation of rotating the disk open/close cover 11 around the disk open/close cover rotation shaft 10 and the operation of rotating the monitor 3 around the monitor rotation shaft 5 are designed so as to be performed independently. Thus, when the disk open/dose cover 11 is rotated in a direction represented by an arrow A to be shifted from the state shown in FIGS. 1A to 1C to the state shown in FIGS. 3A and 3B, a disk-shaped medium is attached to the turntable 12, and the disk open/close cover 11 is closed, the monitor 3 maintains the state shown in FIG. 2, so that the quickness with respect to the photographing operation can be enhanced further, and high operability with respect to photographing can be realized.

In the present embodiment, although a bare disk is used as described above, a disk-shaped medium (a so-called cartridge) accommodated in a case may be configured to be attached/detached. This can be realized by providing a cartridge engagement part capable of holding a cartridge in an opening between the disk open/close cover 11 and the disk apparatus part 4, and further providing a clamper that presses a disk-shaped medium accommodated in a cartridge onto the turntable 12.

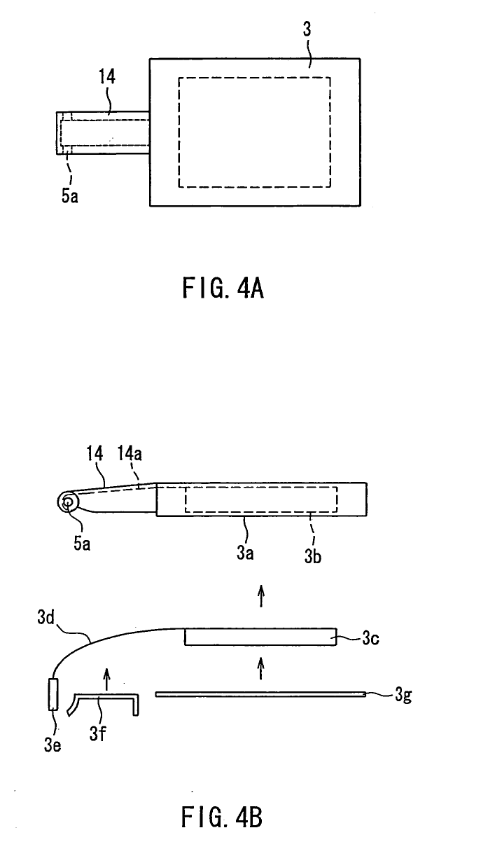

FIGS. 4A and 4B are an enlarged plan view and an exploded side view in the case of applying a liquid crystal display element as the monitor 3 of the present embodiment. As shown in FIGS. 4A and 4B, the monitor 3 includes a monitor cover 3a, a hollow part 3b inside the monitor cover 3a, the display element 3c composed of a liquid crystal display element or the like, a flexible printed circuit (hereinafter, referred to as an FPC) 3d, a terminal electrode 3e, an FPC pressure member 3f, and a transparent protective member 3g. Furthermore, a monitor rotation bearing 5a in which the monitor rotation shaft 5 is fitted is formed in the vicinity of the tip end of the monitor rib 14. Furthermore, a monitor rib hollow part 14 is formed inside the monitor rib 14.

When the monitor 3 is assembled, as shown in FIG. 4B, first, the FPC 3d provided with the terminal electrode 3e supplying a liquid crystal driving current is connected to the display element 3c. Next, the display element 3c with the FPC 3d connected thereto is inserted in the hollow part 3b of the monitor cover 3a. At this time, the FPC 3d is placed so as to be inserted in the monitor rib hollow part 14a and to surround the monitor rotation shaft 5. Next, the transparent protective member 3g that protects the display surface of the display element 3c is attached. Then, the FPC pressure member 3f is mounted in the monitor rib hollow part 14a, whereby the FPC 3d placed in the monitor rib hollow part 14a and on the periphery of the monitor rotation shaft 5 can be fixed.

Owing to the above-mentioned assembly, the terminal electrode 3e can supply a current for driving liquid crystal of the display element 3c from the camera body 2 (actually, a battery mounted in the camcorder), and furthermore, the wiring of the FPC 3d is not exposed from the camcorder. Thus, a camcorder of high quality can be provided, which is capable of realizing a monitor operation having high reliability with the problem such as disconnection suppressed.

In the present embodiment, the monitor rotation shaft 5 and the disk open/close cover rotation shaft 10 are rendered independent from each other, and furthermore, regarding the arrangement at the bearing 13, the monitor rotation shaft 5 is placed on an outer side in an optical axis direction of the lens 1 from the disk open/close cover rotation shaft 10. Therefore, a current supply path to the monitor 3 can be configured simply.

Next, another embodiment of the disk open/close cover will be described.

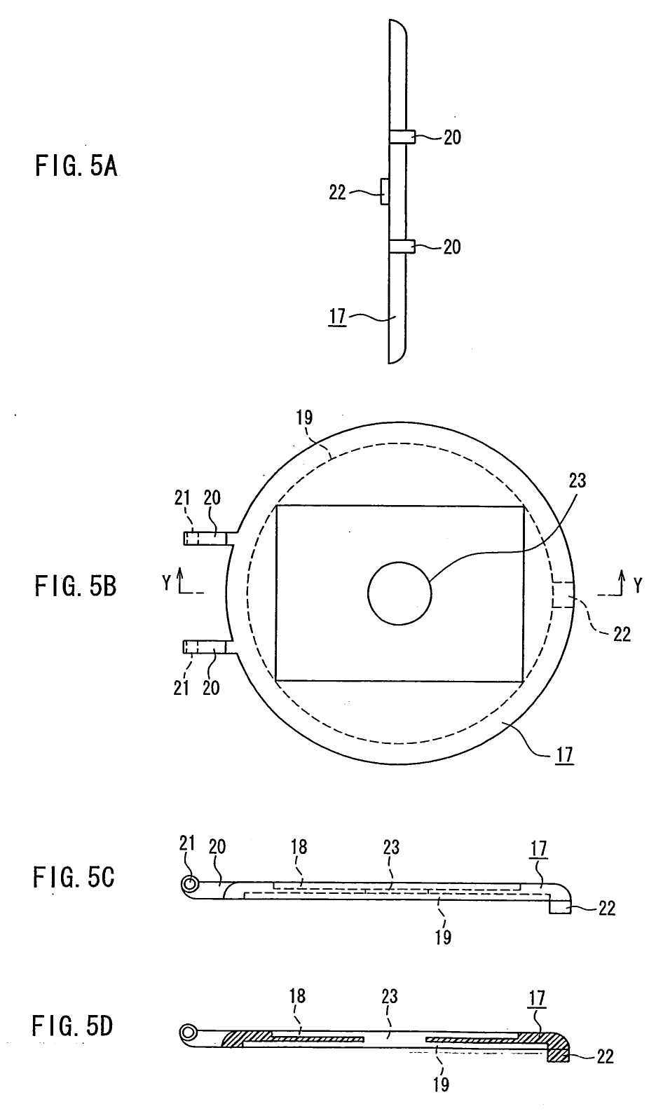

FIG. 5A is a side view showing a right side of a disk open/close cover 17. FIG. 5B is a plan view of the disk open/close cover 17. FIG. 5C is a bottom view of the disk open/close cover 17. FIG. 5D is a cross-sectional view taken along a line Y-Y in FIG. 5B. In FIGS. 5A to 5D, the disk open/close cover 17 includes a monitor accommodating concave part 18 formed on a surface side of the disk open/close cover 17 and having a size capable of accommodating a monitor, a thickness clearance part 19 formed on an inner surface side of the disk open/close cover 17 and composed of a concave part capable of accommodating a disk, a disk open/close cover rib 20, a disk open/close cover bearing 21, and a disk open/close cover engagement part 22.

In FIGS. 5A to 5D, the disk open/close cover 17 is different from the disk open/close cover 11 (see FIG. 1A) in that the monitor accommodating concave part 18 is provided. Owing to the presence of the monitor accommodating concave part 18, when the monitor of the camcorder is accommodated as described later, the monitor comes in the monitor accommodating concave part 18, which enables the thickness of the side surface of the camcorder to be reduced.

Furthermore, as shown in FIGS. 5A to 5D, if a configuration in which the thickness clearance part 19 is provided in the disk open/close cover 17 is adopted, a disk-shaped medium attached to the disk attachment part 4 is buried by the depth of the thickness clearance part 19, so that the thickness of the side surface of the camcorder can be rendered thinner, and the unevenness of the camcorder is suppressed to enhance the quality.

It is assumed that when the monitor accommodating concave part 18 and/or the thickness clearance part 19 are provided in the disk open/close cover 17, the disk open/close cover 17 is deformed due to the decrease in mechanical strength thereof. An external force causing the deformation is exerted, when the disk open/close cover 17 collides with an object when photographing is not being performed with the camcorder or the camcorder is being carried about. However, the camcorder of the present embodiment has its monitor accommodated in the monitor accommodating concave part 18 when the camcorder is being carried about, so that the accommodated monitor prevents the deformation of the disk open/close cover 17.

Furthermore, as shown in FIG. 5D, when an opening 23 is provided at a position of the disk open/close cover 17 corresponding to the turntable 12, the contact between the turntable 12 and the surface of the thickness clearance part 19 can be suppressed, and the thickness of the side surface of the camcorder can be rendered even thinner. When an opening is provided on the periphery of the turntable 12 in the disk apparatus, there is a possibility that dust and the like present in a circumferential environment may be mixed. However, the state in which the opening 23 is opened (i.e., a photographing state) in the camcorder with a monitor lasts for a short period of time, and most of the time, the camcorder is carried about under the condition that the monitor 3 is accommodated. In the present embodiment, when the camcorder is carried about, the opening 23 is closed with the monitor 3. Therefore, a pickup and the like of the disk apparatus part 4 will not be actually contaminated with dust and the like in a circumferential environment.

In the present embodiment, although the case where an opening is formed at a position of the disk open/close cover 17 corresponding to the turntable 12 is described, a non-through hole in which the turntable 12 can be inserted may be formed at a site of the thickness clearance part 19 corresponding to the turntable 12. Owing to this configuration, when the disk open/close cover 17 is closed, a tip end of the turntable 12 can be inserted in the above-mentioned hole, so that the side surface of the camcorder can be made thin while the possibility of allowing dust to be mixed in the disk apparatus part 4 during photographing is suppressed.

Furthermore, the configuration in which the opening 23 or the non-through hole is formed at a place opposed to the turntable is described. For example, in the configuration having a so-called clamper for pressing a disk-shaped medium onto a turntable, as is often seen in the case where a disk-shaped medium is accommodated in a cartridge, it is natural to provide the opening 23 or the non-through hole at the portion corresponding to the clamper. The point is that the opening 23 or the non-through hole may be provided so as to correspond to a portion most protruding to the disk open/close cover 17 side when a disk-shaped medium is attached to the disk apparatus part 4.

Next, another embodiment of the camcorder with the disk open/close cover 17 mounted thereon will be described.

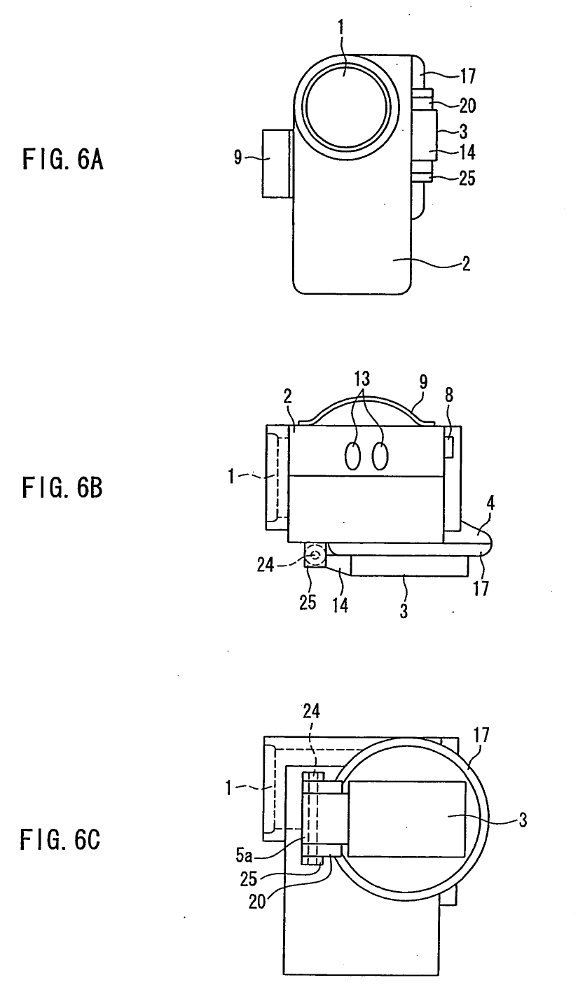

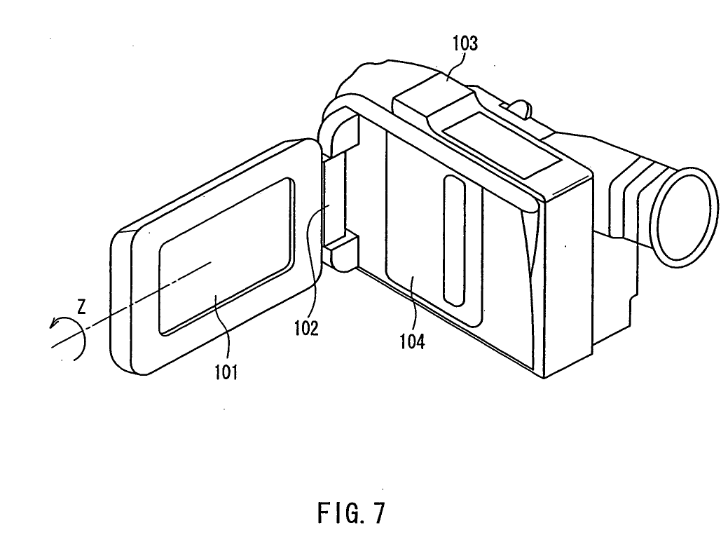

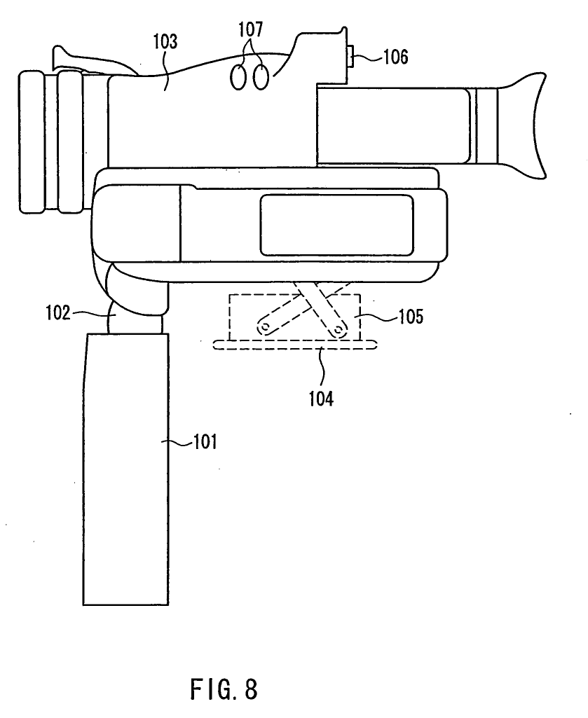

FIG. 6A is a front view of the camcorder with the disk open/close cover 17 mounted thereon. FIG. 6B is a side view on the monitor 3 side. FIG. 6C is a plan view. In FIGS. 6A to 6C, the same components as those in FIGS. 1A to 1C are denoted with the same reference numerals as those therein, and the detailed description thereof will be omitted. A rotation shaft 24 is placed so as to pass through a disk open/close cover bearing 20 and the monitor rotation bearing 5a, and axially supports the monitor 3 rotatably. Furthermore, both ends of the rotation shaft 24 are supported by a bearing 25.

As shown in FIGS. 6A to 6C, the FPC 3d and the like for supplying a current to the monitor 3 in the present embodiment can have the same configuration as that described in FIG. 4, and the same effects are obtained. Furthermore, since the monitor 3 can be accommodated in the monitor accommodating concave part 18 of the disk open/close cover 17, the protrusion amount of the monitor 3 can be reduced. Furthermore, by forming the thickness clearance part 19 and/or the opening 23 (or the non-through hole), the total protrusion amount of the disk apparatus part 4 and the disk open/close cover 17 can be reduced, so that a small and thin camcorder of high quality can be realized.

In the description of any embodiment, the band 9 in which the palm of one hand is inserted is exemplified as a holding assist part. However, the holding assist part is not limited to a band, and may be, for example, a grip part called a “gun grip” or the like protruding from the lower surface of the camera body. Furthermore, for example, in order to prevent the hand movement in a still image camera such as an electronic still camera, on a side part of the camera body, the function of assisting the user to hold the camera body with one hand and the operation function of allowing fingers of one hand to operate a shutter or a release button, which do not exclude a grip or the like formed so as to protrude in the optical axis direction of the lens, may be provided.

Furthermore, in the above-mentioned embodiment, the camcorder capable of recording/reproducing an information signal with respect to a disk-shaped medium is exemplified. In the case of an electronic still camera, a monitor display surface generally is placed so as to be visually recognized on a reverse side of a lens. Therefore, the arrangement direction of a monitor screen is merely varied, and the effect of miniaturization and reduction in thickness owing to the arrangement of the monitor overlapped with a projection plane of the disk open/close cover is the same. Furthermore, by mounting a rotatable monitor as shown in FIG. 1A and the like on the electronic still camera, photographing including a photographer (so-called “self-photographing”) can be performed.

1. An image pickup apparatus that allows a disk-shaped medium having an information layer to be attached/detached and that is capable of recording/reproducing at least a video signal on an information layer of the disk-shaped medium, comprising:
a lens part for allowing optical information incident from outside to form an image on an image pickup part;
a recording/reproducing part including a rotation part provided with a turntable fitted in a center hole of the disk-shaped medium, an optical pickup for transmitting/receiving the video signal with respect to the information layer, and a disk open/close cover covering the disk-shaped medium when the disk-shaped medium is fitted to the turntable part;
a monitor part enabling a video signal output from the image pickup part to be recognized visually; and
a body part in which the lens part, the recording/reproducing part, and the monitor part are placed,
wherein the recording/reproducing part is placed along one outer wall among outer walls constituting the body part, and
the monitor part is placed so as to be overlapped with a projection plane of the disk open/close cover, on an outer surface of the disk open/close cover opposed to the turntable.

2. The image pickup apparatus according to claim 1, wherein the one outer wall having the recording/reproducing part is placed in parallel with an optical axis center of the lens part.

3. The image pickup apparatus according to claim 1, further comprising:
an operation part having a photographing operation part for starting recording of a video signal and stopping recording of the video signal with respect to the information layer, and a zoom operation part capable of performing a zooming operation of a video signal output from the image pickup part; and
a holding assist part for assisting in holding of the body part,
wherein the operation part is placed in a vicinity of the holding assist part.

4. The image pickup apparatus according to claim 1, comprising a concave part that is buried in an outer wall of the open/close cover in a direction toward the rotation part, wherein the concave part is configured so as to accommodate the monitor part.

5. The image pickup apparatus according to claim 1, wherein a rotation shaft of the monitor part is formed coaxially with a rotation shaft of the disk open/close cover.

6. The image pickup apparatus according to claim 1, comprising an opening in a vicinity of a position where the disk open/close cover is opposed to the turntable.
